(19) United States
(12) Patent Application Publication
(10) Pub. No.: US 2015/0213139 A1
(43) Pub. Date: Jul. 30, 2015

(54) COMPUTER IMPLEMENTED METHOD OF PROVIDING A USER PROFILE

(71) Applicant: KING.COM LIMITED, St. Julians (MT)

(72) Inventor: Keith Morgan EDMONDS, Stockholm (SE)

(21) Appl. No.: 14/605,061

(22) Filed: Jan. 26, 2015

Related U.S. Application Data
(60) Provisional application No. 61/931,065, filed on Jan. 24, 2014.

(51) Int. Cl. G06F 17/30; G06F 3/0482; G06F 3/0484

(52) U.S. Cl. CPC G06F 17/30867; G06F 3/04842; G06F 17/3053; G06F 3/0482

(57) ABSTRACT

A computer implemented method is provided which runs on a user device. This method causes the display of a number of selectable options. The user can provide an input via a user interface. Based on the input, an algorithm determines a number of groups associated with a user is determined. Weighted information about the groups is displayed on the display in a normalized manner.

### CROSS-REFERENCE TO RELATED APPLICATIONS

This application is based on, and claims priority to U.S. provisional Application No. 61/931,065, filed Jan. 24, 2014, the entire contents of which being fully incorporated herein by reference.

### FIELD OF THE INVENTION

Some embodiments may relate to a computer-implemented method of matching two or more users.

### BACKGROUND OF THE INVENTION

There are a number of different situations where it is desirable to match two or more people. By way of example, dating websites are provided to allow the matching of two individuals using a matching algorithm. Gaming websites may also want to provide one or more opponents to a given player.

One technical challenge associated with computer-implemented games is how to provide an environment where two or more users can play together or interact. In particular, some computer implemented games may have a very large number of players. Selecting a player at random to play against another player may provide an unsatisfactory experience for one or both of the players if they are mismatched.

One technical challenge associated with so-called dating sites is again how to match two or more people. Again in some situations, there may be a very large number of people registered with a website and the reputation of the website is very dependent on the quality of the matches.

### SUMMARY OF THE INVENTION

According to an aspect, there is provided a computer implemented method comprising: displaying on a display of a user device a plurality of options; receiving via a user interface of the user device user input responsive to the displayed plurality of options; determining by an algorithm running on the user device a plurality of groups with which the user is associated; displaying on the display weighted information about the plurality of groups, the weighted information being normalized to a whole.

The method may comprise displaying the weighted information such that different one of the plurality of groups are graphically distinct.

The different plurality of groups may be displayed using different colors.

The displayed weighted information may comprise a pie chart.

The method may comprise normalizing the weighting of the groups such that the weighted information is normalized to a whole.

In some embodiments, the whole may be 1 or 100%.

The method may comprise responsive to receiving the user input, determining a second plurality of options, the second plurality of options being dependent on the received user input and displaying on the display the second plurality of options.

The groups may comprise one or more of subculture groups; lifestyle groups; social movement groups, counterculture groups, religious groups, gang groups, and fan culture groups. In some embodiments, the groups may alternatively or additionally comprise interests and/or roles

The weighting of the plurality of groups may be determined responsive to user input received from the user via the user interface.

The method may comprise displaying the plurality of groups, each with an equal weighting, receiving user input via the user interface providing weighting information and responsive to the received weighting information, displaying on the display the weighted information.

The user input providing the weighting may comprise receiving user input to modify the displayed plurality of groups.

The method may comprise transmitting to a server weighted information about the plurality of groups, the weighted information being normalized to a whole.

The method may comprise transmitting to a server a request for at least one match with at least one other user in dependence on weighted information about the plurality of groups, the weighted information being normalized to a whole.

The method may comprise receiving from a server information about at least one match.

The method may comprise displaying information about the at least one match.

The displaying information about the at least one match may comprise displaying for at least one other user weighted information about a plurality of groups associated with the at least one other user, the weighted information being normalized to a whole.

In some embodiments, a match score may also be displayed.

According to an embodiment, there is provided a computer implemented method of determining a match between a plurality of user profiles comprising:

selecting in a server a profile of a first user to be matched against a plurality of other user profiles, each user profile providing information about a plurality of groups with which the respective user is associated, the information comprising weighted information about the plurality of groups, the weighted information being normalized to a whole; comparing in the server the selected first user profile and at least one other of the user profiles to determine an extent of a match, the comparing comprising determining an extent of overlap between respective groups of the first user profile and the at least one other user profile; and transmitting match information to at least one user device.

The selecting may be in response to receiving at the server, a request from a user device, the request comprising first user information and the transmitting comprises transmitting the match information to the user device.

The comparing may comprise determining for each subgroup of the first user profile, a scaled value defined by the weighting of a group less the amount of overlap of the group in the first user profile as compared to the at least one other profile.

The comparing may comprise determining for each group of the first user profile which is not in the at least one other user profile a function, the function providing a measure of similarity of the group in the first user profile with a group of the at least one other user profile which is not in the first user profile.

The method may comprise applying one or more criteria to select the at least one other profile to be compared to the profile of the first user.

The method may comprise applying one or more criteria to filter the match information.

According to an aspect, there is provided a user device comprising: a display configured to displaying a plurality of options; a user interface configured to receive user input responsive to the displayed plurality of options; and at least one processor in conjunction with at least one memory configured to run an algorithm, the algorithm configured to determine a plurality of groups with which the user is associated and cause weighted information about the plurality of groups to be displayed on the display, the weighted information being normalized to a whole.

The display may be configured to display the weighted information such that different one of the plurality of groups are graphically distinct.

The different plurality of groups may be displayed using different colors.

The displayed weighted information may comprise a pie chart.

The algorithm may be configured to normalize the weighting of the groups such that the weighted information is normalized to a whole.

In some embodiments, the whole may be 1 or 100%.

The algorithm may be configured responsive to receiving the user input, determine a second plurality of options, the second plurality of options being dependent on the received user input and cause the second plurality of options to be displayed on the display.

The groups may comprise one or more of subculture groups; lifestyle groups; social movement groups, counterculture groups, religious groups, gang groups, and fan culture groups. In some embodiments, the groups may alternatively or additionally comprise interests and/or roles

The weighting of the plurality of groups may be determined by the algorithm responsive to user input received from the user via the user interface.

The algorithm may be configured to cause displaying of the plurality of groups, each with an equal weighting, the user interface may be configured to receive user input via the user interface providing weighting information and responsive to the received weighting information, the algorithm may be configured to cause displaying on the display the weighted information.

The user interface may be configured to receive user input providing the weighting by modifying the displayed plurality of groups.

The user device may comprise a transmitter configured to transmit to a server weighted information about the plurality of groups, the weighted information being normalized to a whole.

The user device may comprise a transmitter configured to transmit to a server a request for at least one match with at least one other user in dependence on weighted information about the plurality of groups, the weighted information being normalized to a whole.

The user device may comprise a receiver configured to receive from a server information about at least one match.

The algorithm may be configured to cause displaying of information about the at least one match on the display.

The displaying of information about the at least one match may comprise displaying for at least one other user weighted information about a plurality of groups associated with the at least one other user, the weighted information being normalized to a whole.

In some embodiments, a match score may also be displayed.

According to an embodiment, there is provided a server configured to determine a match between a plurality of user profiles comprising at least one processor and at least one memory, the at least one processor being configured to run a computer program, the computer program when run is configure to cause: selecting of a profile of a first user to be matched against a plurality of other user profiles, each user profile providing information about a plurality of groups with which the respective user is associated, the information comprising weighted information about the plurality of groups, the weighted information being normalized to a whole; comparing the selected first user profile and at least one other of the user profiles to determine an extent of a match, the comparing comprising determining an extent of overlap between respective groups of the first user profile and the at least one other user profile; and transmitting by a transmitter of the server match information to at least one user device.

The selecting may be in response to receiving at a receiver of the server, a request from a user device, the request comprising first user information and the transmitting comprises transmitting the match information to the user device.

The comparing may comprise determining for each subgroup of the first user profile, a scaled value defined by the weighting of a group less the amount of overlap of the group in the first user profile as compared to the at least one other profile.

The comparing may comprise determining for each group of the first user profile which is not in the at least one other user profile a function, the function providing a measure of similarity of the group in the first user profile with a group of the at least one other user profile which is not in the first user profile.

The computer program when run may be configured to cause applying one or more criteria to select the at least one other profile to be compared to the profile of the first user.

The computer program when run may be configured to be apply one or more criteria to filter the match information.

According to an embodiment, there is provided a server configured to determine a match between a plurality of user profiles comprising at least one processor and at least one memory, the at least one processor being configured to run a computer program, the computer program when run is configured to cause: selecting of a profile of a first user to be matched against a plurality of other user profiles, each user profile providing information about a plurality of groups with which the respective user is associated, the groups being subculture groups; comparing the selected first user profile and at least one other of the user profiles to determine an extent of a match, the comparing comprising determining an extent of overlap between respective groups of the first user profile and the at least one other user profile; and transmitting by a transmitter of the server match information to at least one user device.

The profile may be as previously described.

According to an embodiment, there is provided a computer implemented method of determining a match between a plurality of user profiles comprising: selecting in a server a profile of a first user to be matched against a plurality of other user profiles, each user profile providing information about a plurality of groups with which the respective user is associated, the groups being subculture groups; comparing in the server the selected first user profile and at least one other of the user profiles to determine an extent of a match, the comparing comprising determining an extent of overlap between respective groups of the first user profile and the at least one other user profile; and transmitting match information to at least one user device.

The profile may be as previously described.

According to an aspect, there is provided a computer implemented method comprising: displaying on a display of a user device a plurality of options; receiving via a user interface of the user device user input responsive to the displayed plurality of options; determining by an algorithm running on the user device a plurality of groups with which the user is associated, the groups being subculture groups; displaying on the display information about the plurality of groups.

According to an aspect, there is provided a user device comprising: a display configured to displaying a plurality of options; a user interface configured to receive user input responsive to the displayed plurality of options; and at least one processor in conjunction with at least one memory configured to run an algorithm, the algorithm configured to determine a plurality of groups with which the user is associated, the groups being subculture groups; and cause information about the plurality of groups to be displayed on the display.

It should be appreciated that any of the features described above may be used in combination with any other of the featured described previously.

### BRIEF DESCRIPTION OF DRAWINGS

For a better understanding of some embodiments, reference will now be made by way of example only to the accompanying drawings in which:

FIG. 1 shows a flowchart of a method;

FIG. 2 shows a first example a displayed user profile;

FIG. 3 shows an example of two user profiles which are being matched;

FIG. 4 shows a second example of two user profiles which are being matched;

FIG. 5 schematically shows a general system of some embodiments;

FIG. 6 schematically shows a data structure of some embodiments;

FIG. 7 schematically shows a gaming system in which some embodiments may be provided;

FIG. 8 schematically shows a user device;

FIGS. 9a and 9b show a flow chart for determining a profile of the user; and

FIG. 10 shows a flow chart for matching.

### DETAILED DESCRIPTION OF SOME EMBODIMENTS

Some embodiments may deal with a number of technical challenges. A first challenge is define a profile of a user which can be easily displayed and easily understood. A profile of a user may be quite complex and reducing the profile such that it can be graphical displayed and simply modified by a user is technically challenging. Another technical challenge is to how to match people without requiring substantial processing capability.

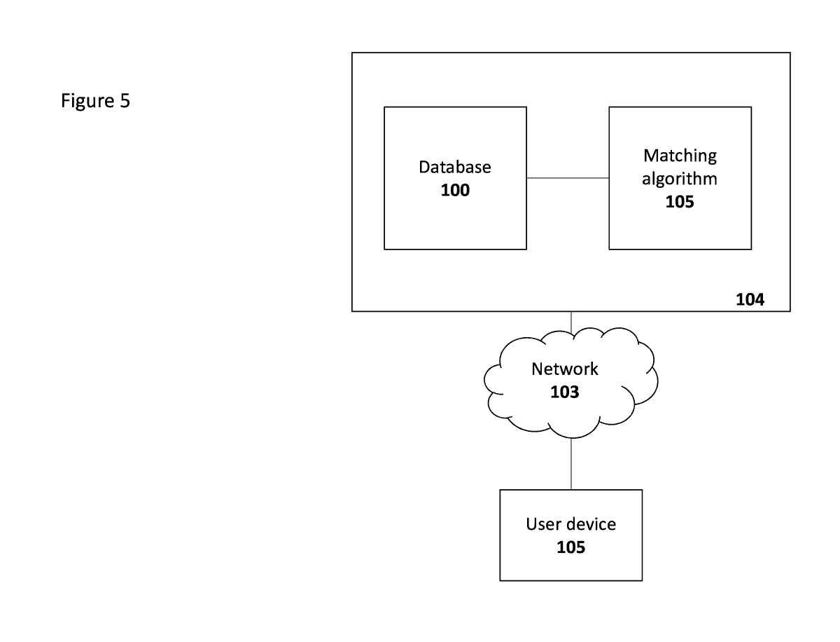

Reference is made to FIG. 5 which shows a general arrangement in which some embodiments may be provided. In the system shown in FIG. 5, one user device 105 is shown but in practice there will be many more devices. The user device may be any suitable user device. The user device is able to communicate with at least one server 104. In some embodiments a plurality of servers are provided. In the example shown a single server is shown.

The server 104 has a database 100 and at least one processor which is able to run a matching algorithm 102. In some embodiments, the database and the matching algorithm may be provided by different entities.

The database is configured to store information about a plurality of different users. At least some of the stored information about a user may be used by the matching algorithm to allow at least one other user to be identified as a potential match.

Communication between the user devices and the server may be via a network 103.

In the following, matching of users or people are described in the context of matching players in a computer implemented game and matching of users for an online dating application. However, it should be appreciated that this is by way of example only and the matching algorithm may be used in any other scenario where matching of users is required.

In the first example a user may be a player of a game. The user may interact with another user. For example that user may play against or with another user, one user may help or assist another user, one user may rank themselves against another user, one user may request assistance from another user, one user may communicate with another user and/or have any other suitable interaction. In other embodiments, the user may want to have a social interaction with another user, but using the gaming environment and may not necessarily be wanting a match for playing a game. The interaction may involve two or more users. In the following reference is made to a player. However, it should be appreciated that embodiments may be applied to any other suitable user. In some embodiments, the matching can be used to identify groups of people who form a team or clan. Some games may people in different clans or teams playing against each other. Other games may require players in a clan or team to play collaboratively.

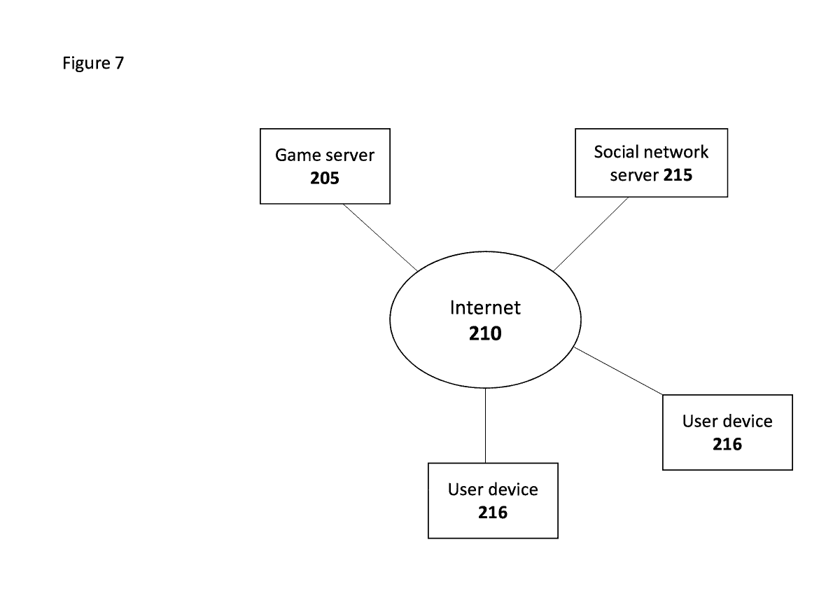

Reference is made to FIG. 7 which shows an example of a gaming system in which in some embodiments may be provided. A computer game is stored on a game server 210. In some embodiments, the computer game may be stored on a user device. The computer game may be downloaded to the user device or installed on the user device in any suitable way.

The game may be played on the user device 216. The user device may be any suitable device such as a computer, smart phone, any other handheld device, a kiosk, arcade gaming station, smart TV, any suitable device with computing capabilities, input devices and a screen that can present the game to a player, or the like.

The user device communicates with the game server 205 via for example the Internet 210 and/or any other suitable communications infrastructure. In some embodiments, the communications may be via http-requests.

In some embodiments, the user device may be configured to communicate with a social network server 215. In some embodiments, the social network server may be omitted.

In some embodiments, the social network server 215 and the game server 205 may be provided by a single server.

In some embodiments, a game server 205 may be provided by a plurality of game servers. The social network server 215 may be provided by one or more servers.

The database and matching algorithm are provided by one or more servers as discussed in relation to FIG. 5.

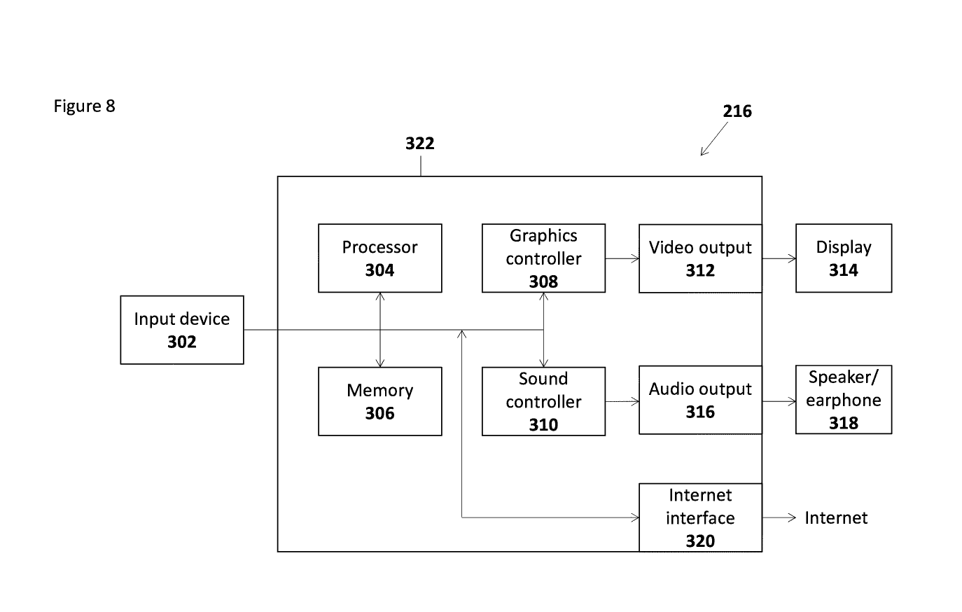

A schematic view of a user device 216 is shown in FIG. 8. All of the blocks shown are implemented by suitable circuitry. The blocks may be implemented in hardware and/or software. The user device may have a control part 322. The control part 322 has one or more processors 304 and one or more memories 306. The control part 322 is also shown as having a graphics controller 308 and a sound controller 310. It should be appreciated that one or other or both of the graphics controller and sound controller may be provided by the one or more processors 304.

The graphics controller 8 is configured to provide a video output 312. The sound controller 310 is configured to provide an audio output 316. The controller 322 has an interface 324 allowing the device to be able to communicate with the Internet or other communication infrastructure.

The video output 312 is provided to a display 314. The audio output 316 is provided to an audio device such as a speaker and/or earphone(s) 318.

The device 216 has an input device 302. The input device can take any suitable format and can be one or more of a keyboard, mouse, touch screen, joystick or game controller. It should be appreciated that the display 314 may in some embodiments also provide the input device.

The blocks of the controller 322 are configured to communicate with each other by an interconnect such as a bus or any other suitable interconnect and/or by point to point communication.

It should be appreciated that in some embodiments, the controller 322 may be implemented by one or more integrated circuits, at least in part.

The user device is shown by way of example only. In alternative embodiments, one or more of the parts may be omitted. Alternatively or additionally, some embodiments may comprise one or more other parts. Alternatively or additionally, one or more parts may be combined.

Some methods of matching may use a social network such as Facebook or the like. Various methods of building networks of people have been suggested and may use one or more of phone books, email, google+, and applications which select a potential match for a user. However, these methods all require the player to create the list of friends to play against or otherwise interact. These methods are not particularly effective at matching a player with new players.

Some embodiments may provide a method of matching which may be independent of social network connections. However, some embodiments may additionally use social network information as an additional parameter for matching.

Generally the number of people accessing a particular websites, such as a gaming or a dating website may be large, sometimes of the order of millions. In some scenarios, the pool of people available for matching may be of a social network which again may have a very large number. Given that a large number of people is available for matching, it is likely that there will be a number of good matches available for a given person.

It is not straight forward to determine a suitable match. There are methods which have been attempted but generally these methods have not been particularly successful. Either the matches which are achieved are not particularly good or the amount of information which a person has to provide may be very large. For example one reasonably effective method requires a person to answer hundreds of questions.

Some dating websites have attempted to match two individuals based on the personalities of the individuals. However, this is some suggestion that there may not be a significant correlation between personality similarities/dissimilarities and relationship satisfaction.

Personality tests are well known and require the user to input answers to a detailed questionnaire. For example, some tests can measure traits such as social (extroversion), change (openness), organized (conscientiousness), pleasing (agreeableness), and emotional stability (low neuroticism).

Personalities which score highly in these five areas are “nice” people. Some matching algorithms will reject those that score poorly in these areas. Thus, some algorithms only include those people who are “nice” and rejecting more difficult personalities. This does not match individuals but rather only includes people who are considered “nice”. These types of algorithm are filtering for normative personalities.

As will be described, in some embodiments, it is desirable to provide questions which allow the one or more sub-cultures with which an individual identifies to be determined.

Social bonds may rely heavily on subconscious stereotypes. Upon new face to face social interactions people size up others in a short amount of time. These determinations are often accurate but can be hard to assess quantitatively in research. Stereotypes can be useful. Large differences may exist between people which can be exaggerated through salient social identity situations. People use many visual and auditory clues to help categorize.

In the context of on-line situations, the information which is available in face to face contexts is not available. Generally, people tend to get along better with people they cannot see. However, the on-line situation does mean that they may not be able to make an in-group/out-group. People often have trouble distinguishing between two groups when they belong to neither. In the absence of information, there is a tendency to fill in the unknown characteristics with positive information. When meeting online, the lack of input can lead to mis-categorization.

People have a natural tendency to find contrast and use this to self-categorize. Contrast is use for category formation. People tend to categorize objects in order to understand them. This is done for themselves and their peers as well, when forming group stereotypes. Generally there may only be a group when there is some salient out-group. A group may only be defined when it is clear when someone is not part of the group. In other words, there may be contrast on which to base the group. Self-categorization may lead to group identification. Group identification may come from one or more of perceived similarity, presence of a dissimilar out-group, salience of group membership and common enemy/goal.

A consequence of this is that at least subconsciously everybody has some idea of the groups people belong to. These groups may be clique, social class, role, region, etc. Often these groups may be a source of pride and self-esteem and may give people a sense of belonging to the social world. A person will generally socially identify with their social group. Often this can lead to animosity toward those who are not part of the group, that is out-group. Often there will be perceptions of out-group as immoral or dishonest. A person will tend to favour those who are in the same group. There may be one or more of a greater liking, respect, cooperation friendliness, greater perceived competence, quality, tendency to believe other members of the group are more like themselves, and a tendency to embrace the social norms of the group.

Typically there is attraction among individuals who share the same social experience and context. Similarity may be a measure of how likely we are to get on with another person. People tend to see themselves as more similar to those in-group and less like those out-group. Once someone has identified themselves as belonging to a group, they tend to exaggerate the in-group/out group contrast.

Some matching algorithms attempt to exploit a similarity attraction effect. These algorithms require information about interests and hobbies. However, these matching algorithms may not be particularly successful in that the interests may not say much about the accepted idioculture of the person. Interests is a different metric which is being matched on than social identity. Some embodiments may aim is to have both. Interests mean that people can do something together. Shared idioculture means they may interact well. In principle both are needed but having something to do may be easy to find for two people socialized into a similar set of idiocultures.

As will be described in more detail later, some embodiments will use social identity in order to determine a match.

In general people are more selective in larger pool with more options, as is the situation in online environments. Those people who are able to better express themselves in the online context generally may achieve better matches. People who express themselves better online may identify with their online persona more. When that persona is accepted by others they will feel more accepted than if the persona was a facade. Put another way, the better the information defining an individual, the better the matches. As mentioned previously, some embodiments use group information in order to match people. This group information may reflect a person's social identity.

These groups may for example be a sub culture. An interest is generally different from a group. For example, a subculture generally will provide information about a person's clustering behaviour. In contrast, interests are merely correlated with the person's social identity. For example, an example of a subculture would be the punk subculture which would define certain values, certain behaviours etc. An interest would be a liking of punk music without necessary identifying with the punk subculture.

There are different types of groups. Some groups may be all encompassing of lifestyle. For example orthodox religious social identity or skin head will general be all encompassing. Other groups can fit in with others. For example a hippy social identity may fit in with the professional social identity. Other social identities may be opposite, for example punk vs hippy, vegetarian vs hunter, academic vs redneck.

A person's social group or identity is who that person has been socialized with. Unlike the current matching algorithms social identity or group is used in a matching algorithm of some embodiments. It should be appreciated that social group cannot simply be defined by for example race, gender, religion or age, the proportion of time spent doing certain things and interests.

Generally, at least some people can be defined by more than one social identity or group which may or may not share certain characteristics.

People may derive their identity or sense of self largely from the social groups or categories to which they belong. Each person, however, over the course of their personal history, is socialised in a combination of social categories. Therefore, the set of social groups which the person identifies with are combined to make a self-concept

Some embodiments are such that matching is based on the understanding that generally a person belongs to a combination of social groups. This provides a set of social identities which define that person's self-concept. Embodiments may match based on shared idioculture. This contrasts with current matching algorithms which match based on interests. Matching based on interests has the disadvantage that affinity for particular things or media generally does not have any relation to shared idioculture.

In contrast, embodiments use the social identity or groups to determine matches. Generally a good match may be achieved with someone having a similar social identity profile.

Some embodiments will allow a person to self-categorize by selection of the social groups to which they consider they identify. People may identify with a social group's idioculture and subsequently self-categorize themselves in a social context.

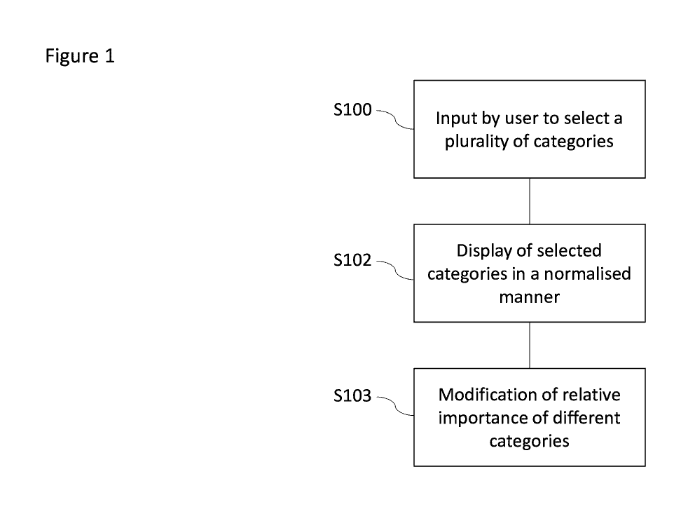

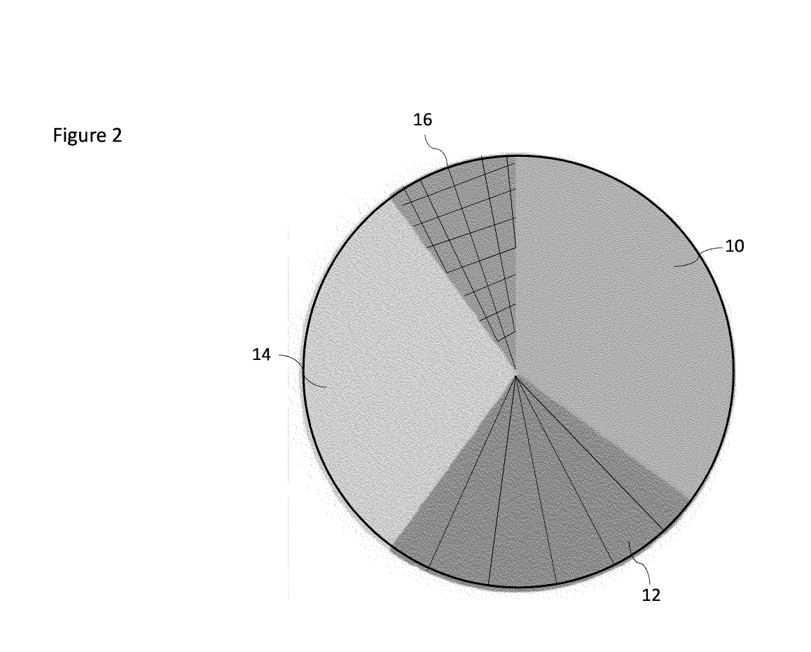

Other embodiments will provide a series of questions to assist in this categorization of the user. Some embodiments may use a mixture of these two methods. Reference is made to FIGS. 1 and 2. In some embodiments, a profile for a user is created. The profile is based on one or more social groups of a person. This profile can be created in any suitable manner. The profile which is created is represented graphically as shown in FIG. 2. A method for implementing an embodiment is broadly described in relation to FIG. 1.

In step S100 the user provides input to select one or more social groups. Preferably a user is prompted to select more than one social groups. In some embodiments, the user may be asked to select n social groups where n is an integer of any suitable value, for example between 4 and 10. In some embodiments, there may be a limit on the number of social groups which can be selected by a user. In other embodiments, there may not be any such limit.

For this an input data collecting algorithm may be running either locally on the user device and/or remotely on a server in the case of a web-based application. An example of the data collecting algorithm is described in more detail later.

The input data collecting algorithm is configured to present at least one and preferably more input screens to a user. The input screens will display one or more questions and/or options and the user is prompted to provide input. As described below, the input data collection may be an iterative process with the answers presented to a first set of options and/or questions controlling the options and/or questions which are next presented to the user.

For example, in one embodiment, the user may be presented with a set of social groups and the user is able to select one or more of these groups.

The user may be presented with an initial sub set of options and based on the selected options, the user may be presented with a further subset of options. This may be repeated so that selecting from the further subset of options may provide a further sub set of options. Each subset of options may be completely different to the previous set or may contain one or more options which have been previously presented. In some embodiments the initial set of options may be broad and selection of a given option may result is a more refined break down of options for that selected option being presented to the user.

In some embodiments, the options are presented so that they may be selected or not, for example by ticking a box.

It should be appreciated that one or more social identities have sub groups. Some embodiments may provide questions to allow the one or more sub groups of a particular subculture to be defined.

In another approach, the user may be asked to input some more basic data such as sex, location, age, religion, and based on that basic data, the initial subset of options may be selected for a user.

In some embodiments, the user may be asked to list one or more of interests, hobbies, occupation or the like and based on this the initial subset of options may be selected for display. Candidate social groups can be selected based on the user's input.

In preferred embodiments, the user is only asked questions for which there are one or more predefined options and/or asked to select one or more options.

It should be appreciated that in some embodiments, one or more of the options or questions may allow a negative input. For example a question may ask the user to select an option which he dislikes or with which he disagrees.

Some embodiments may permit the user to provide information indicating one or more of specific likes or interests, roles and status. In some embodiments at least some of this information is used in the determination of the social identities. In other embodiments, at least some of this information may be provided subsequently.

This information may give credibility to a claim of social group membership. For example, a professional athlete has a strong claim on being in the athlete subculture. However, they may not be in that subculture but just like the sport. It is possible for someone to like something without identifying with the associated culture.

Subculture or social identity may matter more than common interests. For example two academics will get along well even if they are in different fields. However a literature professor and a person who likes to read are less likely to get on and are more likely to have a different social identity.

Some roles may form groups. For example the military has a strong idioculture and many people who have a role in the military may identify with the military group. However, having a role in the military does not imply identification with the group. Nor does identification with the group imply a role related to the group.

Once the input data has been selected and the user has selected the social groups relevant to himself, the next step is step S102 where the selected categories are displayed in a normalised fashion. One example of how this is achieved is shown in FIG. 2. In this Figure, the selected social groups are shown on a pie chart. In the example shown, the user has selected four different social groups 10, 12, 14 and 16. Each group may be displayed using a different visual representation. The visual representation may comprise colour, pattern, labels and/or the like. In some embodiments colour may be used as it allows a user to instantly see how similar they are to another person. This is discussed later.

It should be appreciated that this only one example of how the information can be displayed. Other embodiments may use different shapes such as a rectangle or the like to display the different groups. In another embodiment, the information may be displayed along a line. In another embodiment, the groups may be displayed as a list with a percentage or other normalised number.

The inventor has appreciated that all the social identities associated with a user may not have the same importance or relevance to that user. In some embodiments, the different social identities are weighted. The sum of the weightings will be a whole. The whole maybe a 100%, 1 or any other defined whole.

In some embodiments, in step S103, the user is able to adjust the relative importance of one social identity with respect to another. In the example shown in FIG. 2, the user is able to adjust the size of the slice of the pie chart to reflect the relative importance. In the example of FIG. 2, the social identity referenced 16 has a much lower importance than the other three categories.

In some embodiments, the initial information presented to the user in step S102 may have not any weighting associated with it. For example, the initial version of the pie chart may have all of the social identities weighted with the same importance and the user then modifies the weighting.

In some embodiments, the data collecting algorithm may assign initial weighting to each of the selected social identities. This may be responsive to input provided by a user.

In some embodiments, the user may be able to alter the relative importance by moving boundaries on a shape and/or by moving a slider and/or by changing a number. In some embodiments, the representation of the selected social identities is normalised to for example 1 or 100%. If one social identity is increased or decreased in importance, the importance of at least one other social identity will need to be correspondingly altered to retain the appropriate normalised value.

In some embodiments, an iterative approach may be supported. For example the user may define an initial profile but then may over time refine the profile by electing to answer further questions and/or by adding and/or deleting social identities. In some embodiments, because the visual representation of the data is clear, a user may be modify his profile responsive to viewing other profiles either to improve the match or to reduce the match.

In some embodiments, some applications such as gaming databases may already have some information about a user. Some embodiments may allow the addition of social identification information to that information.

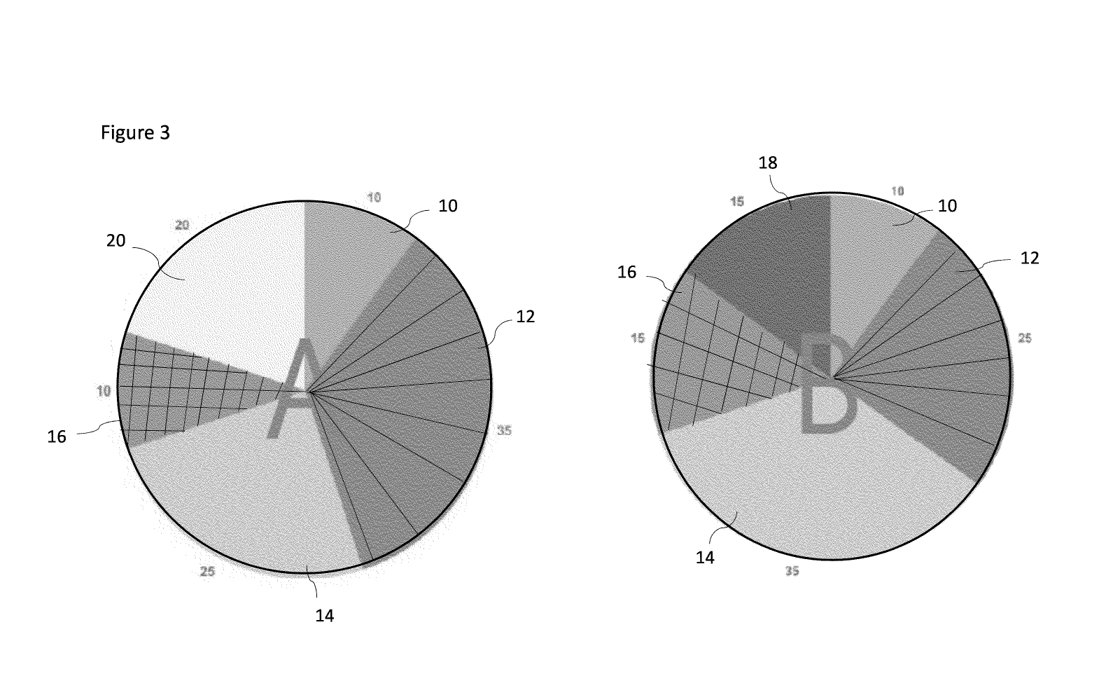

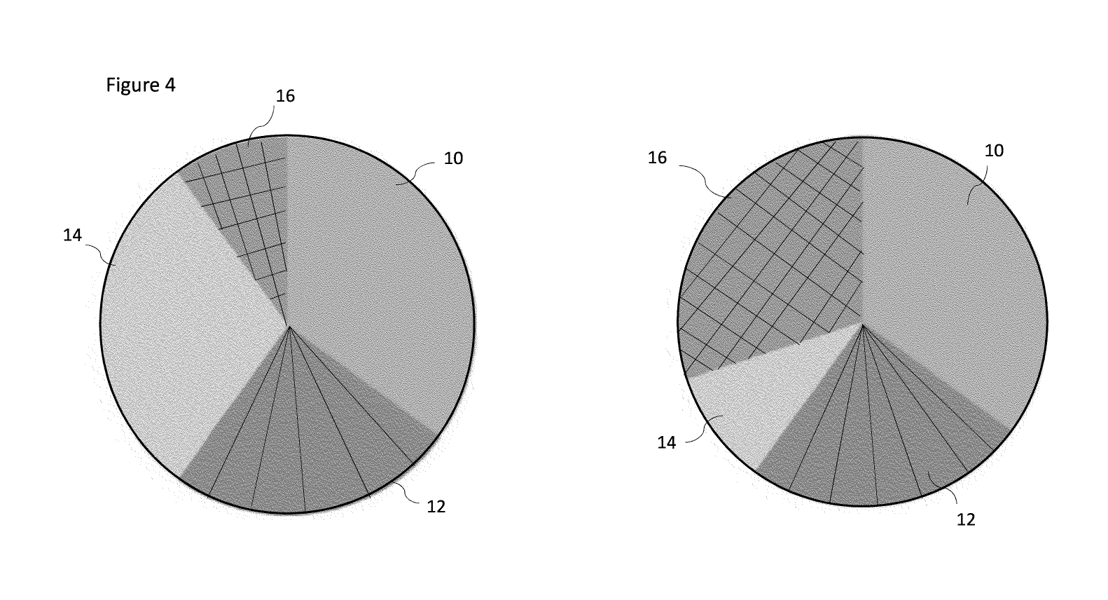

Reference is made to FIGS. 3 and 4 which show examples of how a match is determined.

An example equation is set out below. The equation has a first term which is measure of the similarity, a second term which is a measure of differences and a third measure which reflects the similarity between two different groups.

A∩B+αΣ_{k∈(B)}A−(A∩B))ₖ+Σ_{i∈(A-B)}maxf(i,j)Aᵢ

k<={B}i∈{A−B}

where α∈(0,1) is tuneable

f(i,j) ∈(0,1) <α is a function which returns the similarity of two subcultures or social identities. For example, this could be based on a number of nodes of separation provided in a social graph of subculture. User defined voting may be used. For example, users may be asked to vote on how similar they believe two groups are and then use that data to define F(i,j).

This may be a non-symmetric measure which favors the searchers groups. Other embodiments may have symmetric measures.

Consider the example of the perfect match. In a perfect match, the pie chart of two users will be identical, having the same social identities in the same proportion.

Consider the example of FIG. 4 which shows a close match. In this example, the two users have the same social identities but with different weightings.

Match=A∩B+αΣ_{k∈(B)}A−(A∩B))ₖ

The first term measures the overlap and the second term measures the missed overlap scaled by α. In other words, how much the given social identity of the first user does not overlap that social identity of the second user, all scaled by α.

Consider the case of FIG. 3 where the two charts are shown. Each has five social identities. Chart A and B share four common social identities and one different.

The first term considers for chart A how much match there is for a given social identity. For example if a first social identity is 25% in chart A and 35% in chart B, then the value of overlap is 25%. If the second social identity in chart A is 35% in chart A and 25% in chart B, the overlap is again 25%. In some embodiments, percentage values are used and in other embodiment a normalised value of for example 1 is used. Some embodiments may use a mixture of these techniques. The resulting value is a sum resulting from this analysis for each common social identity.

The second term is based on the value of the first social identity in the first chart minus the amount of overlap between the first chart and the second chart. This is done for all of the social identities of the second chart. The values are summed and then multiplied by the scaling factor.

This may favour the dominant groups.

The final term is based on any one or more social identities in the first chart and not the second chart. This is defined by max f(the social identity in question, j) multiplied by its weighting. A value is returned which is dependent on the social groups in question.

In some embodiments, potential matches may be displayed such that the matches which are close to or are perfect are displayed first with decreasingly good matches following. In some embodiments, where there a number of results having the same score, the results may ordered taking into account one or more other metrics such as region, sex, age, friends of friends or the like. In some embodiments, one of more metrics may be used to pre-filter the lists. In some embodiments, one or more criteria may be selected by the user. In some embodiments, one or more criteria may be selected by the matching algorithm.

Some embodiments may be such that so-called normative problem is taken into account. Many people fit into the norm. Less normative groups more readily self-categorize. Normative people may not be very easy to classify into a subculture. However, they can be thought of as a group and they may identify themselves as not being a particular group. There may be strong identification through work, family and/or activities. For some of these people, the associated subculture is defined by their role or career. The input options will allow the user to select these options as their social identity or the questions will allow the identification of the role or career as their social identity.

In some embodiments, alternatively or additionally the social groups which the user strongly disagrees with or has opposing idioculture may be determined. This may be used in determining the social identity of a user.

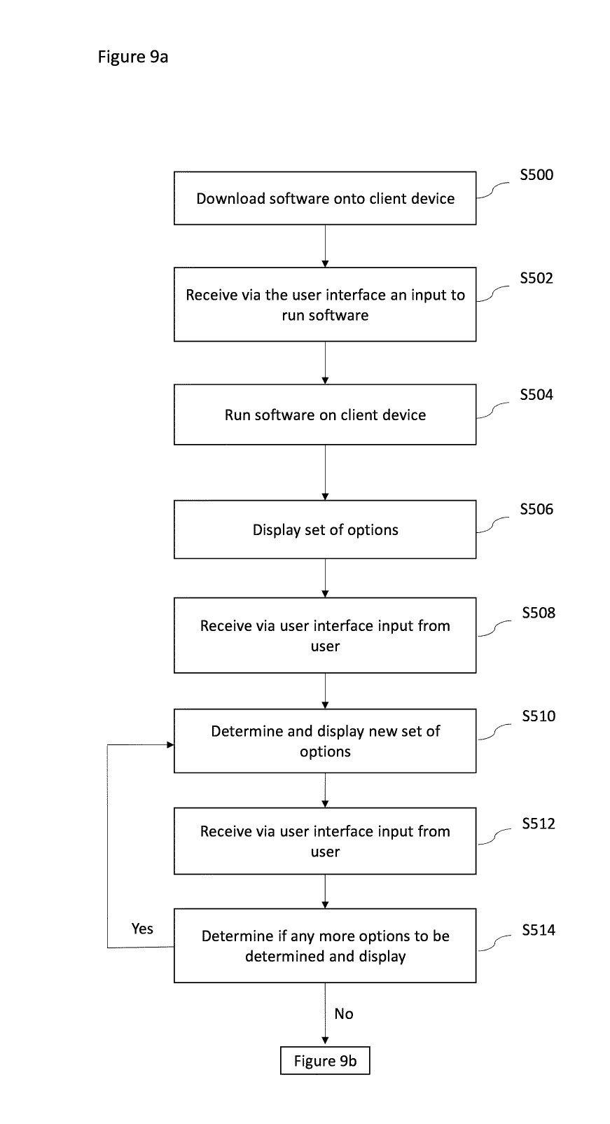

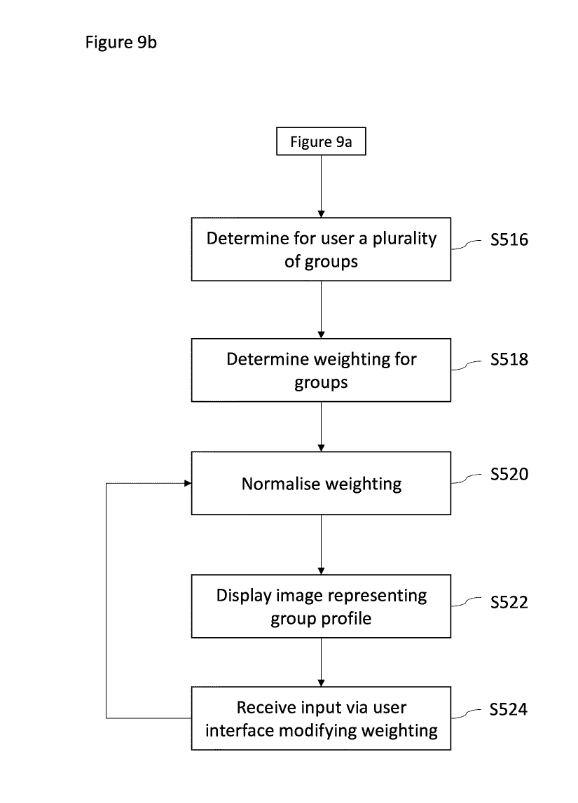

Reference is made to FIGS. 9a and 9b which shows a method of an embodiment. In the following, the method of FIGS. 9a and 9b may be implemented in a client device, such as the user device as described in FIG. 8. The method may be implemented by computer software running on one or more processors. The processor may operate in conjunction with one or more memories to run the computer software. It should be appreciated that in other embodiments one or more of the steps shown may be carried out in the server. In that case, information will need to be transmitted and received between the user device and the server.

In the method flow of FIG. 9a, the first step S500 is the downloading of software onto the client device. Of course, where the software is already stored on the client advice, then this step may be omitted.

In step S502, the user interacts with the user interface to provide an input. Thus, the processor of the device is configured to receive from the user interface an input which causes the running of the software. This may be by the selection of an associated application.

In step S504, the software is run on the client device.

In the step S506, the running of the client software will cause the display of a set of options. It should be appreciated that the same set of options may be displayed for all users. In other embodiments, the software on the client device may ascertain or have information about the user and this information may control the set of options which are displayed. These options may be tick box options and/or questions which have a predefined set of answers. The first set of options may be displayed on the display in such a way as to include an input area next to each option. This is to encourage the user to input the information into that area. It should be appreciated that any of the previously describe option and/or question scenarios can alternatively or additionally be used here.

In step S508, input is received from the user via the user interface. This provides a response to the displayed set of options. For example, a tick may be provided next to one or more options. Alternatively or additionally, one of the plurality of answers to a particular question may be selected.

The software is configured in step S510 to determine based on the received input from the user of a new set of options which are then displayed, as described in relation to step S506. It should be appreciated in some embodiments, this step may be optional.

As in step S508, in step S512, user input is received from the user via the user interface to the displayed set of options.

In step S514, the software is configured to determine if any more options are to be determined and displayed. For example, there may be a limit on the number of sets of options which can be provided to a user. If there are more options to be determined and displayed, then the next step will be step S510 as already described. If no more options are to be displayed the method moves to the flow of FIG. 9b.

Reference is made to FIG. 9b. It is determined in step S516 by the software a plurality of groups for the user. This will be dependent on the information received in response to the displayed options.

In step S518, a relative weighting is determined for the groups. In some embodiments, an initial weighting where each of the groups are equally weighted may be provided. The initial weighting may be determined by the algorithm or may be controlled by the user.

In step S520, the software is configured to normalize the weighting. It should be appreciated that in some embodiments, this may be part of the step of S518. In some embodiments, the weighting is normalized to a whole. In some embodiment, the whole may be considered to be 100%. In other embodiments, the whole can be considered to be one. In other words, the weighting is such that the total weighting will always add up to the value of the whole being used.

In step S522, an image is displayed which represents the user's social group profile. This for example may be the pie chart or any of the other examples previously described.

In step S524, the user is able to provide input via the user interface. Thus, the software will receive input from the user by the user interface which modifies the weighting. In other words, the relative weighting of the different groups may be changed. It should be appreciated that if the weighting is modified, the normalizing of the weighting is carried out, for example as in step S520. Again, the normalizing of the weighting may be part of step S524.

It should be appreciated that the determining of the weighting of the groups may be determined by the software, determined by the input provided by the user or a combination there of. Where the weighting is determined by the user, an initial equal weighting of the groups may be provided, and steps S518 and S520 may be omitted. The steps may then be carried out after the image has been displayed and the user has modified the relative weights.

The profile may be used in matching processes such as described below. In some embodiments, the profile may be displayed alongside other information of the user as part of the user's whole profile.

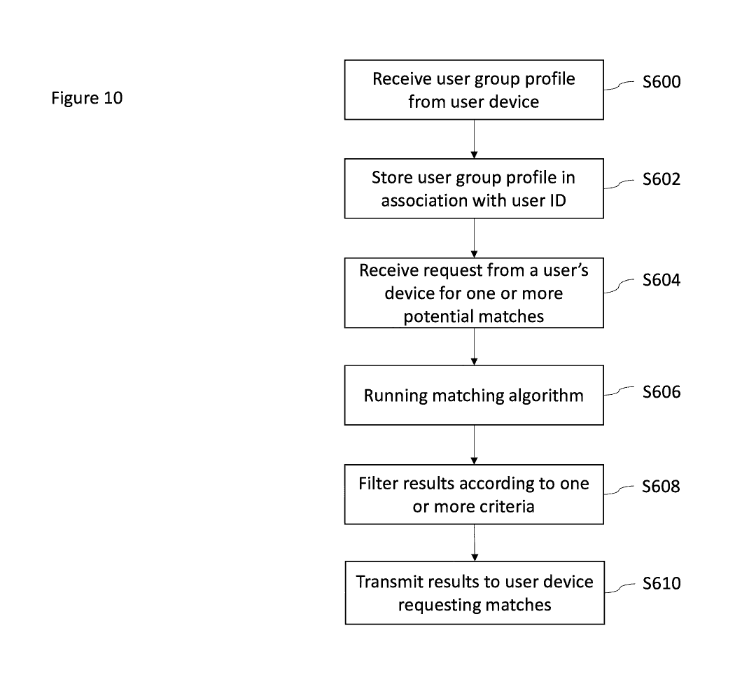

Reference is made to FIG. 10 which shows a flow which is carried out in the matching process. In step S602, a server will receive a user's social group profile from a user device. This user profile may be created as for example described in relation to FIGS. 9a and 9b. In practice, the server will receive profiles from a number of different user devices.

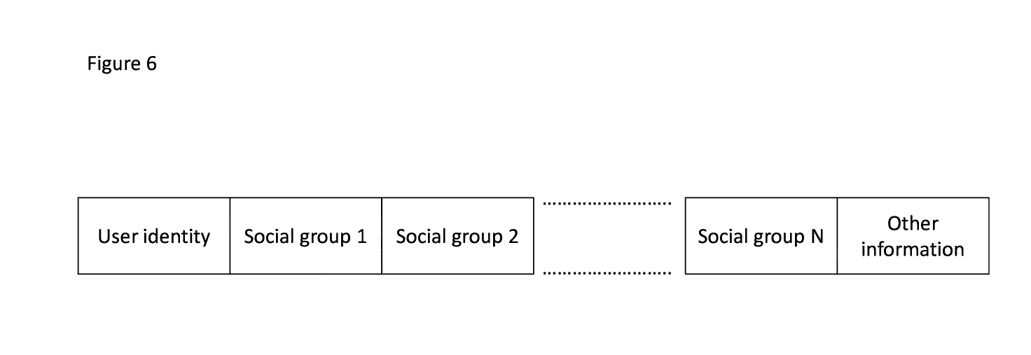

In step S602, the server will store in the database the user's group profile in association with the user's identity. Reference is made to FIG. 6 which schematically shows a data structure for some embodiments. The data structure comprises user identity information which can take any suitable form. In some embodiments, a user may have a plurality of identities and they may be stored in the same data structure. Each of the user's N social groups are identified and stored in the data structure along with their associated weight. The data structure may in some embodiments include other information, such as sex, location, language or the like. In the context of a gaming environment, gaming information may also be stored.

In step S604, the server will receive a request from a user device for one or more potential matches. This may be a specific request for a match or may be a game related request which prompts the finding of a match.

In step S606, the server is configured to run the matching algorithm. The matching algorithm may compare the user's profile with a number of other user profiles, as described for example previously in relation to FIGS. 3 and 4. For each comparison, a score is provide which will range between x and y where x is where there is not match at all and y is a perfect match. In some embodiments x may be 0 and y may be 1. In other embodiments x may be 0 and y may be 100. In other embodiments, x and y can take any other suitable values.

In step S608, the server is configured to filter the results according to one or more criteria. In other embodiments, the criteria may be applied prior to running a matching archive. This would be for example to only include the other users that are in a particular location, speak a particular language and/or the like. This step may be optional in some embodiments.

The server is configured in step S610 to transmit one or more results to the user device which requested the matches. The results may be displayed in the user device. The displayed results may comprise the pie chart or the like. Alternatively or additionally, this may be displayed alongside score information. The results may be ordered.

The determination of the user's social sub-culture may be used in the matching process of some embodiments. Some embodiments may be done iteratively to improve the profile of the user. Some embodiments may use the user's introspection and/or the knowledge gained from browsing of similar users. The introspection and self-awareness of a user may help once the basic concept is understood by a user. Viewing other profiles may help with this and/or receiving suggestions from other users. Although the representation of a profile (e.g. using a pie chart) may be simple the underlying content to be expressed may be as complex as a written description a user might write of themselves on a dating site.

A user thus may need to be prompted to create an initial set of sub-cultures when they first create this portion of their profile. This may be to explain what the intent of this profile feature is to the user in order to help them expand on the initial profile. Secondly, even if the user understands the concept the threshold for entry should be relatively low to encourage adoption.

In some embodiments, the initial profile may be created with a series of questions each of which having multiple answers. A user selects at least one of the proposed answers and then they proceed to the next question. The set of questions and order of them may not be the same for each user. The questions should “drill down” on the previously acquired information.

For example an initial question could be “Do you often engage in athletics or sports with your circle of friends?”. The wording of the question may be such to bring to light what the user does with their current friends. This means that it may be directly related to their socialization. Possible answers could be “I do not like sports and athletics”, “We like to watch”, “I mostly play solo sports”, “Yes I play sports with my friends”. The list of answers to questions may be set up such that it covers all possible answers but does so without too many choices, e.g. less than 10. If the user answers “I do not like sports and athletics” then this line of questioning should be abandoned and the next question should pertain to something of a non-athletic nature. If the user answers “We like to watch” then they could be older former athletes, soccer moms or just enjoy watching the game as a social activity. The follow up questions should attempt to discern between these. If they answer “I mostly play solo sports” this may indicate a particular lifestyle like an outdoors person (e.g. hiker) or a professional athlete (gymnast). These may or may not be defining of the user's social identity. If the users answers “Yes I play sports with my friends” then the follow up questions should try to differentiate based on the particular sport.

This is just an example of one question in a multi-question process. In some embodiments, a user may not like to answer too many questions as the user will likely bore of the process. Once enough questions have been asked to suggest over N sub-cultures the user would be asked which they social identify with. N may be any suitable number, for example between 10 and 20 although N may be higher or lower than these example numbers. The user select a subset of z options, where z is less than N. This would then produce an interactive pie chart with the selected subcultures populated. The slices may all be equally weighted and the user would be asked to adjust the size relative to one another. This would then complete the initial set up of the user's profile.

This may not be the complete set of relevant social sub-cultures for that user and they may be told as such. The user may be prompted to look at other user profiles and add or remove sub-cultures. This can be done through choosing from a list or by typing having an auto complete text suggestion function. The user may be reminded that not all groups will be possible. In some embodiments, some groups can be thought of as a combination of other groups.

Some fringe groups do exist which users are particularly devoted to. A user may be given the option of creating a new one group and asked to complete their profile from what is currently available.

A subculture may be considered to a relatively diffuse social network having a shared identity, distinctive meaning around certain ideas, practices, and objects, and a sense of marginalization from or resistance to a perceived conventional society.

Some embodiments may use one or more of the following to define social groups: lifestyle, social movement, counterculture, religious movements, gangs, fan culture and subculture in a profile of a user. Some embodiments may use subcultural groups.

The displaying of groups in the normalized manner may be used with groups that represent interests or the like in some embodiments.

For some games, a player may wish to play against one or more other players or interact with one or more other players.

Some embodiments may be used with games which potentially have a very large number of players. In one embodiment, a subset of the players is selected as players with which a particular player can interact. This may be performed by the processor in the gaming server. Alternatively or additionally a separate server function may be provided to select the subset of players. The separate server function may be different to the server function which is managing game play.

Some embodiments may prioritize the selection of players which are active in the same game.

In some embodiments, a first user may be presented with the option of interaction with one or more users of the subset of users allocated to the first user. Information about the one or more users of the subset may be received from the server and may be displayed. When a second user is selected for interaction, information is sent from the device of the first user to the device of the second user. Alternatively or additionally information may be sent from the server to both the user device of the first user and the user device of the second user. Information from the user device of the first user may be displayed on the user device of the second user. The connection may be via the server and/or via the internet. Any other suitable communication path may be provided. Information from the first user may be displayed on the user device of the second user. There may be a two way communication path between the first and second users. In some situations, there may be interaction between more than two users.

Various methods have been described. It should be appreciated that these methods will be implemented in apparatus, where the apparatus is implemented by any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

It is also noted herein that while the above describes exemplifying embodiments of the invention, there are several variations and modifications which may be made to the disclosed solution without departing from the scope of the present invention.

We claim:

1. A computer implemented method comprising:
displaying on a display of a user device a plurality of options;
receiving via a user interface of the user device user input responsive to the displayed plurality of options;
determining by an algorithm running on the user device a plurality of groups with which the user is associated;
displaying on the display weighted information about the plurality of groups, the weighted information being normalized to a whole.

2. A computer implemented method as claimed in claim 1, comprising displaying the weighted information such that different one of the plurality of groups are graphically distinct.

3. A computer implemented method as claimed in claim 1, wherein the displayed weighted information comprises a pie chart.

4. A computer implemented method as claimed in claim 1, comprising normalizing the weighting of the groups such that the weighted information is normalized to a whole.

5. A computer implemented method as claimed in claim 1, comprising responsive to receiving the user input, determining a second plurality of options, the second plurality of options being dependent on the received user input and displaying on the display the second plurality of options.

6. A computer implemented method as claimed in claim 1, wherein the groups comprise one or more of subculture groups; lifestyle groups; social movement groups, counterculture groups, religious groups, gang groups, and fan culture groups.

7. A computer implemented method as claimed in claim 1, wherein the weighting of the plurality of groups is determined responsive to user input received from the user via the user interface.

8. A computer implemented method as claimed in claim 1, comprising displaying the plurality of groups, each with an equal weighting, receiving user input via the user interface providing weighting information and responsive to the received weighting information, displaying on the display the weighted information.

9. A computer implemented method as claimed in claim 8, wherein the user input providing the weighting comprises receiving user input to modify the displayed plurality of groups.

10. A computer implemented method as claimed in claim 1, comprising transmitting to a server weighted information about the plurality of groups, the weighted information being normalized to a whole.

11. A computer implemented method as claimed in claim 1, comprising transmitting to a server a request for at least one match with at least one other user in dependence on weighted information about the plurality of groups, the weighted information being normalized to a whole.

12. A computer implemented method as claimed in claim 11, comprising receiving from a server information about at least one match.

13. A computer implemented method as claimed in claim 12, comprising displaying information about the at least one match.

14. A computer implemented method as claimed in claim 12, wherein the displaying information about the at least one match comprises displaying for at least one other user weighted information about a plurality of groups associated with the at least one other user, the weighted information being normalized to a whole.

15. A computer implemented method of determining a match between a plurality of user profiles comprising:
selecting in a server a profile of a first user to be matched against a plurality of other user profiles, each user profile providing information about a plurality of groups with which the respective user is associated, the information comprising weighted information about the plurality of groups, the weighted information being normalized to a whole;
comparing in the server the selected first user profile and at least one other of the user profiles to determine an extent of a match, the comparing comprising determining an extent of overlap between respective groups of the first user profile and the at least one other user profile; and
transmitting match information to at least one user device.

16. A computer implemented method as claimed in claim 15, wherein the selecting is in response to receiving at the server, a request from a user device, the request comprising first user information and the transmitting comprises transmitting the match information to the user device.

17. A computer implemented method as claimed in claim 15, wherein the comparing comprises determining for each subgroup of the first user profile, a scaled value defined by the weighting of a group less the amount of overlap of the group in the first user profile as compared to the at least one other profile.

18. A computer implemented method as claimed in claim 15, wherein the comparing comprises determining for each group of the first user profile which is not in the at least one other user profile a function, the function providing a measure of similarity of the group in the first user profile with a group of the at least one other user profile which is not in the first user profile.

19. A computer implemented method as claimed in claim 15, comprising applying one or more criteria to select the at least one other profile to be compared to the profile of the first user.

20. A user device comprising:
a display configured to displaying a plurality of options;
a user interface configured to receive user input responsive to the displayed plurality of options; and
at least one processor in conjunction with at least one memory configured to run an algorithm, the algorithm configured to determine a plurality of groups with which the user is associated and cause weighted information about the plurality of groups to be displayed on the display, the weighted information being normalized to a whole.

21. A server for enabling matching of a first user profile to at least one other user profile, the server comprising:
a data store wherein the data store comprises profile data for the first user profile and profile data for the at least one other user profile, each user profile providing information about a plurality of groups with which the respective user is associated, the information comprising weighted information about the plurality of groups, the weighted information being normalized to a whole;
a receiver configured to receive from a user device for a match of the first user profile to at least one other user profile;
at least one processor configured to select at least one other user profile and compare the first user profile and the selected at least one other user profile to determine an extent of a match, the comparing comprising determining an extent of overlap between respective groups of the first user profile and the at least one other user profile; and
a transmitter configured to transmit the server match information to at least one user device.
